(19) United States
(12) Patent Application Publication
(10) Pub. No.: US 2018/0226708 A1
(43) Pub. Date: Aug. 9, 2018

(54) Substrate integrated coaxial line wave guide interconnection array structure

(71) Applicant: SHANGHAI JIAO TONG UNIVERSITY, Shanghai (CN)

(72) Inventors: Xiaochun Li, Shanghai (CN); Yan Shao, Shanghai (CN); Ning Wang, Shanghai (CN); Bin Yuan, Shanghai (CN); Junfa MaMao, Shanghai (CN)

(21) Appl. No.: 15/749,505

(22) PCT Filed: Aug. 26, 2015
(86) PCT No.: PCT/CN2015/088164

§ 371 Date: Feb. 1, 2018

(30) Foreign Application Priority Data
Aug. 24, 2015 (CN) 201510524372.9

(51) Int. Cl. H01P 3/06

(52) U.S. Cl. CPC H01P 3/06

(57) ABSTRACT

A substrate integrated coaxial line (SICL) array is proposed in this invention. The SICL array includes at least a single channel. The inner conductor is between the first outer conductor layer and the second outer conductor layer. The first dielectric layer is between the first outer conductor layer and the inner conductor layer. The second dielectric layer is between the inner conductor layer and the second outer conductor layer. The metal vias columns are across the structure in vertical direction. The first outer conductor layer, the second outer conductor layer and the metal vias columns form the outer conductor. Many single channels in horizontal and vertical directions form the array, and adjacent channels share outer conductors. Vertically adjacent channels share outer conductor layers, and horizontally adjacent channels share metal vias. The SICL array can be used as board level/package level/chip level interconnects.

### CROSS REFERENCE OF RELATED APPLICATION

This is a U.S. National Stage under 35 U.S.C. 371 of the International Application PCT/CN2015/088164, filed Aug. 26, 2015, which claims priority under 35 U.S.C. 119(a-d) to CN 201510524372.9, filed Aug. 24, 2015.

### BACKGROUND OF THE PRESENT INVENTION

### Field of Invention

The invention relates to the board level/package level/chip level high-speed data transmission technical field, specifically, relates to a substrate integrated coaxial line array structure.

### Description of Related Arts

The development of the society leads to the increasingly urgent demand for terabit data transmission rate. To meet the demand, the high-speed electric interconnect technology becomes the key to the realization of the system. Conventional interconnects, such as the microstrip line, stripline and coplanar waveguide (CPW), support the propagations of quasi-TEM or TEM wave, and are not suitable for Terabit data transmission since high loss at high frequency. The high loss results from their open structure. What's more, the loss increases dramatically as frequency increases, which limits the distance and speed of the signal transmission. The signal integrity problem and electromagnetic interference (EMI) problem, such as crosstalk, delay, distortion, and inter-symbol interference are serious when transmission rate is higher than gigabit. SERDES technology is able to reduce crosstalk, but decrease transmission density. Equalization and pre-emphasis technology is able to compensate the high frequency loss of conventional electric interconnects and expand the band, which lead to high cost and unable to avoid EMI problems. In a word, conventional electric interconnects is not able to meet the requirements of the new generation data transmission, and new types of electrical interconnects need to be developed for the high-speed data transmission. Substrate integrated waveguide (SIW) which comprises an upper, a lower conductor plates and metal vias columns is a high-pass device with low loss. However, the dominant mode of SIW is TE10 and hence it unable to support the transmission of the baseband signal directly. Modulation and de-modulation devices are needed in SIW-based transmission system to shift baseband signal to the pass band of SIW, which increase the complexity of the system and limits the bandwidth.

As a discrete device, the single-channel SICL has a quasi-shielding structure, which has the advantages of low loss, low delay, low crosstalk, and strong ability to resist EMI. SICL is suitable for the transmission of the baseband signal because of the dominant TEM wave. However, the data transmission rate of a single channel SICL has limitation.

### SUMMARY OF THE PRESENT INVENTION

Conventional open-structure interconnects, such as microstrip line, stripline and CPW have the disadvantages of low data rate, high loss and weak ability to resist EMI, and the data transmission rate of a single channel SICL is limited. To overcome these problems, SICL array is proposed in the invention, which is able to integrate the coaxial line array to the substrate. The outer metal layers and the metal vias form the outer conductors, the inner metal layers form the inner conductors, and the dielectric layers form the dielectric between inner conductors and outer conductors of the SICL array. Multichannel parallel data transmission is realized by the SICL array. The SICL array proposed in the invention has the advantages of low loss, low delay, low crosstalk and strong ability to resist EMI, which is suitable for multichannel parallel data transmission to enhance data transmission rate.

To achieve the above purpose, the invention is realized by the following technical schemes:

An SICL array is a quasi-shielding structure. The physical structure of the SICL array from the top to the bottom includes at least a single channel structure. The single structure includes the first outer conductor layer, the first dielectric layer, the inner conductor layer, the second dielectric layer, the second outer conductor layer and the metal vias columns.

The inner conductor is between the first outer conductor layer and the second outer layer. The first dielectric layer is between the first outer conductor layer and the inner conductor layer. The second dielectric layer is between the inner conductor layer and the second outer conductor layer.

The metal vias columns are across the single channel structure in a vertical direction.

Preferably, the first outer conductor layer, the second outer conductor layer and the metal vias columns form the outer conductor of the single channel structure. Many single channel structures in horizontal and vertical directions form the array, and adjacent channels share outer conductors. The SICL array comprises of many single channels.

Preferably, two vertically adjacent single channel structures share the same outer conductor layer, that is, the second outer conductor layer of the upper channel is the first outer conductor layer of the lower channel.

Preferably, there are two columns of metal vias, which are arranged along the length direction of the physical structure of the array with same distance between adjacent vias. The horizontally adjacent channels share the same metal vias column.

Preferably, each metal vias column comprises several metal vias, and the distance between adjacent vias is the same.

Preferably, the metal via diameter is d, the distance between adjacent vias is s, and the distance between two metal vias columns is a.

The number of metal vias in each column depends on the length of the physical structure.

Preferably, the thickness of the first outer conductor layer, the inner conductor layer and the second outer conductor layer is t, the thickness of the first dielectric layer and the second dielectric layer is h, and the length of the physical structure is 1.

Preferably, the inner conductor has at least a metal structure, which is arranged between two adjacent metal vias columns in the width direction of the physical structure.

Preferably, the metal structure width is b, and b is smaller than the width of the outer conductor layer.

Preferably, the first outer conductor layer and the second outer conductor are metal layers.

Preferably, TEM wave is used in the SICL array to propagate signal, and multichannel transmission is able to be realized.

The SICL array proposed in the invention comprises shared outer conductors and several independent inner conductors, wherein dielectric is between the outer conductors and inner conductors. Take the 2×2-channel SICL array as an example, the SICL array has 9 layers from the top to the bottom, that is, the first layer is metal layer L1 (the first outer conductor layer of the first row channels), the second layer is dielectric layer L2 (the first dielectric layer of the first row channels), the third layer is metal layer L3 (the inner conductor layer of the first row channels), the fourth layer is dielectric layer L4 (the second dielectric layer of the first row channels), the fifth layer is metal layer L5 (the second outer conductor layer of the first row channels and the first outer conductor layer of the second row channels), the sixth layer is dielectric layer L6 (the first dielectric layer of the second row channels), the seventh layer is metal layer L7 (the inner conductor layer of the second row channels), the eighth layer is dielectric layer L8 (the second dielectric layer of the second row channels), the ninth layer is metal layer L9 (the second outer conductor layer of the second row channels). The m×n-channel SICL array is able to be analogized from the 2×2-channel SICL array, in which n is the number of rows in vertical direction, and m is the number of columns in horizontal direction. The SICL array proposed in the invention is a quasi-shielding structure. Signal is transmitted by TEM wave in the SICL array, and parallel data transmission with multichannel is able to be realized. The SICL array is able to be used as board level/package level/chip level interconnects. Compared with conventional open-structure microstrip line/stripline/CPW, the SICL array has advantages of wide band, low delay, low crosstalk and good electromagnetic compatibility, which is suitable for high speed multichannel data parallel transmission above gigabit. The proposed SICL array is expandable in horizontal and vertical directions.

Compared with the conventional technology, the invention has the following advantages.

1. The SICL array proposed in the invention is a quasi-shielding structure, and signal is transmitted by the TEM wave. Compared with the conventional open-structure microstrip line/stripline/CPW, the SICL array has advantages of wide band, low delay, low crosstalk and strong ability to resist EMI.

2. Compared with SIW which uses TE10 wave to transmit signal, the SICL array do not need any modulation or demodulation device, so it has the advantages of low loss, high speed, simple implementation and low cost.

3. Compared with the single-channel SICL, the SICL array is able to support multichannel and parallel data transmission.

4. The SICL array is able to be used as board level/package level/chip level interconnects for high-speed data transmission.

### BRIEF DESCRIPTION OF THE DRAWINGS

Features, purposes and advantages of the invention becomes more obvious by the detailed description of the non-restrictive embodiments with reference to the following figures.

FIG. 1 is an illustration of a single channel of an SICL array proposed in the invention;

FIG. 2 is an illustration of a 2×2-channel SICL array structure;

FIG. 3 is an illustration of an n×m-channel SICL array structure;

FIG. 4 is S21 of a channel in the SICL array;

FIG. 5 is S11 of a channel in the SICL array.

Element numbers:
1 is metal layer L1; 2 is dielectric layer L2; 3 is metal layer L3; 4 is dielectric layer L4; 5 is metal layer L5; 6 is dielectric layer L6; 7 is metal layer L7; 8 is dielectric layer L8; 9 is metal layer L9;

10, 11, 12 and 13 are four independent metal structures of inner conductor layers, which are denoted as the first metal structure, the second metal structure, the third metal structure and the fourth metal structure, respectively;

14, 15 and 16 are three columns of metal visa;

5 is shared by vertical channels and 15 is shared by horizontal channels.

### DETAILED DESCRIPTION OF THE PREFERRED EMBODIMENT

The following embodiment of the invention is explained in detail. The implementation is based on the technical scheme of the invention, and the detailed implementation method and the specific operation process are given. It should be pointed out that the general technical personnel in the field are also able to make some modifications and improvements without departing from the conception of the invention, all of which are within the protection scope of the invention.

To realize the substrate integration of coaxial line array in board level/package level/chip level, an SICL array is proposed in the embodiment.

The SICL array proposed in the embodiment is a quasi-shielding structure. The physical structure of SICL array from the top to the bottom comprises at least a single channel structure, which comprises the first outer conductor layer, the first dielectric layer, the inner conductor layer, the second dielectric layer, the second outer conductor layer and two meal vias columns.

The inner conductor layer is between the first outer conductor layer and the second outer conductor layer. The first dielectric layer is between the first outer conductor layer and the inner conductor layer. The second dielectric layer is between the inner conductor layer and the second outer conductor layer.

The metal vias columns are across the single channel structure in vertical direction.

Furthermore, the first outer conductor layer, the second outer conductor layer and the metal vias columns form the outer conductor of the single channel structure. Many single channels in horizontal and vertical directions form the array, and adjacent channels share outer conductors. The SICL array comprises of many single channels.

Furthermore, two vertically adjacent single channel structures share the same outer conductor layer, that is, the second outer conductor layer of the upper channel is the first outer conductor layer of the lower channel.

Furthermore, there are two columns of metal vias, which are arranged along the length direction of the physical structure of the array with the same distance between adjacent vias. The horizontally adjacent channels share the same metal vias column.

Furthermore, each metal vias column comprises several metal vias, and the distance between adjacent vias is the same.

Furthermore, the metal via diameter is d, the distance between adjacent vias is s, the distance between two metal vias columns is a.

The number of metal vias in each column depends on the length of the physical structure.

Furthermore, the thickness of the first outer conductor layer, the inner conductor layer and the second outer conductor layer is t; the thickness of the first dielectric layer and the second dielectric layer is h; the length of the physical structure is l.

Furthermore, the inner conductor has at least a metal structure, which is arranged between two adjacent metal vias columns in the width direction of the physical structure.

Furthermore, the metal structure width is b, and b is smaller than the width of the outer conductor layer.

Furthermore, the first outer conductor layer and the second outer conductor layer are metal layers.

Furthermore, TEM wave is used in the SICL array to propagate signal, and multichannel data parallel transmission is able to be realized.

Take the 2×2-channel SICL array as an example. 5 metal layers and 3 columns of metal vias form the outer conductors and inner conductors. 4 dielectric layers form the dielectric between inner conductors and outer conductors. The SICL array is suitable for high-speed multichannel data transmission.

In particular, the SICL array comprises shared outer conductor and several independent inner conductors, and dielectric between outer conductors and inner conductors. The number of channels is able to be expanded in horizontal and vertical directions. The SICL array has 9 layers from the top to the bottom, that is, the first layer is metal layer L1, the second layer is dielectric layer L2, the third layer is metal layer L3, the fourth layer is dielectric layer L4, the fifth layer is metal layer L5, the sixth layer is dielectric layer L6, the seventh layer is metal layer L7, the eighth layer is dielectric layer L8, and the ninth layer is metal layer L9.

The metal vias columns are between metal layer L1 and metal layer L9, which are across the layers from the first one to the ninth one. The metal vias columns are composed of 3 columns of metal vias along the length direction of the physical structure of SICL array.

Metal layer L1, metal layer L5, metal layer L9 and metal vias columns are used as the outer conductors. Metal layer L3 and metal layer L7 are used as the inner conductors.

Dielectric layer L2, dielectric layer L4, dielectric layer L6 and dielectric layer L8 are used as the dielectric between inner conductors and outer conductors.

Furthermore, the thickness of metal layer L1, metal layer L3, metal layer L5, metal layer L7 and metal layer L9 are all the same, which is denoted as t, the thickness of dielectric layer L2, is the same as that of the dielectric layer L4, the dielectric layer L6, the dielectric layer L8, which is denoted as h. The length of the SICL array is denoted as l.

Furthermore, the metal structure width of metal layer L3 is the same as that of the metal layer L7, which is denoted as b, wherein b is smaller than the width of metal layer L1, the width of the metal layer L5 and the width of the metal layer L9. The metal layer L3 and the metal layer L7 are between the two adjacent columns of metal vias in the width direction of the SICL array.

Furthermore, the metal via diameter is d; the distance between adjacent vias is the same, which is denoted as s the distance between two metal vias columns is a.

Furthermore, TEM wave is used in the SICL array to propagate signal, and since the SICL array is a multichannel structure which enables parallel data transmission.

The embodiment is further described with the following figures.

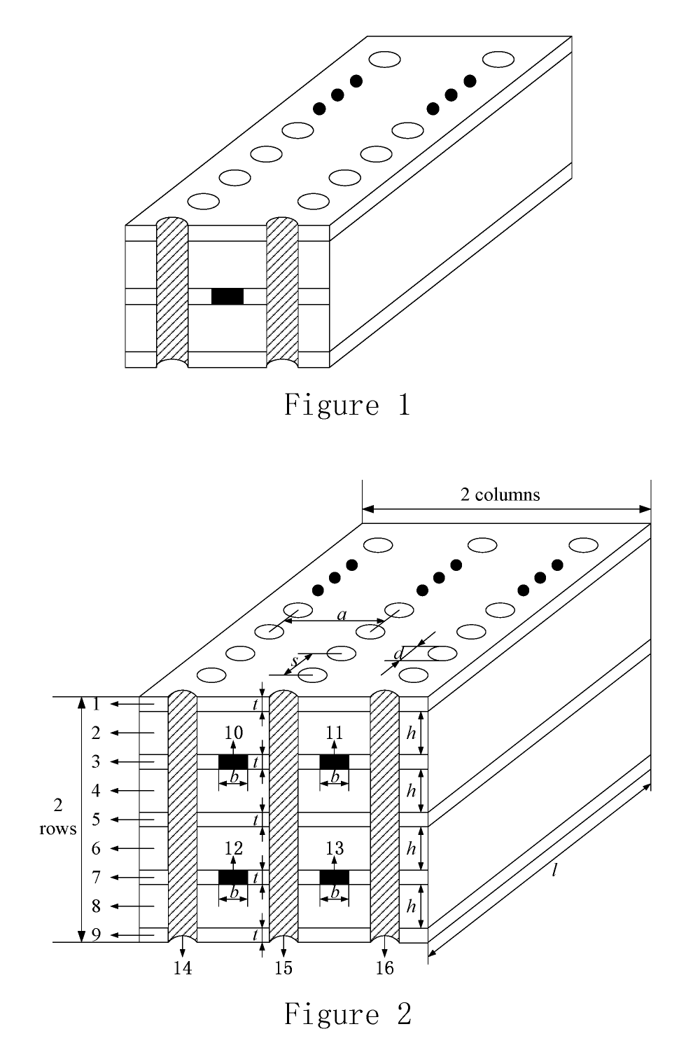

FIG. 1 is a single channel of the SICL array proposed in the invention, which comprises the outer conductor, the inner conductor and the dielectric between them; wherein the single channel of the SICL is formed by 3 metal layers and 2 dielectric layers. The SICL array is able to be formed by expanding the single channel structure horizontally and vertically.

FIG. 2 is a diagram of the SICL array when the numbers of rows and columns are both 2. The 2×2-channel SICL array comprises the outer conductor, the inner conductor and the dielectric between them, wherein the SICL array is formed by 5 metal layers and 4 dielectric layers. TEM wave is used in the SICL array to propagate the signals.

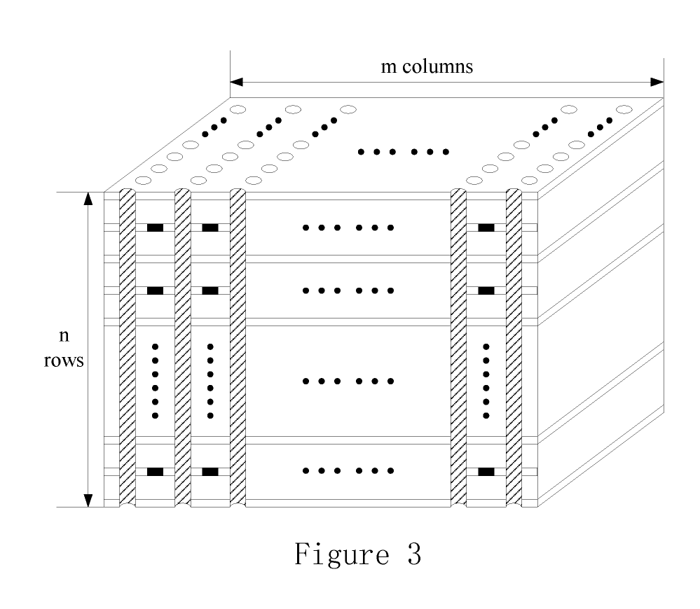

The m×n-channel SICL array has m×n channels, as shown in FIG. 3, wherein n is the number of rows and m is the number of columns, wherein n and m are any positive integers.

Take the 2×2-channel SICL array in FIG. 2 as an example.

The SICL array has 9 layers from the top to the bottom, that is, the first layer is metal layer L1, the second layer is dielectric layer L2, the third layer is metal layer L3, the fourth layer is dielectric layer L4, the fifth layer is metal layer L5, the sixth layer is dielectric layer L6, the seventh layer is metal layer L7, the eighth layer is dielectric layer L8, the ninth layer is metal layer L9. The thickness of the 5 metal layers is t, the thickness of the two dielectric layers is h, and the length of the SICL array is l.

The outer conductor comprises metal layer L1, metal layer L5, metal layer L9 and three columns of metal vias between metal layer L1 and metal layer L9. The metal via diameter is d, the distance between adjacent vias is s, the distance between two metal vias columns is a.

The inner conductor comprises the metal layer L3 and the metal layer L7, wherein the width of the metal structure in L3 and L7 is b.

The dielectric comprises the dielectric layer L2, the dielectric layer L4, the dielectric layer L6 and the dielectric layer L8, which are between the inner conductors and outer conductors.

The characteristic impedance of the channel in the SICL array is denoted as Z0, and is usually designed to be 50Ω. Z0 is able to be estimated by

$${Z}_{0} = \frac{30 π}{\sqrt{{ɛ}_{r}}} \frac{2 h}{b + 0.882 h}$$

in which, εᵣ is the relative permittivity of dielectric.

The working band of the SICL array is from dc to fTE10. fTE10 is the cutoff frequency of the TE10 mode and is able to be estimated by

$${f}_{TE 10} = \frac{c}{2 \sqrt{{ɛ}_{r}}} {( a - \frac{{d}^{2}}{0.95 s} )}^{- 1}$$

in which, c denotes the speed of light in vacuum.

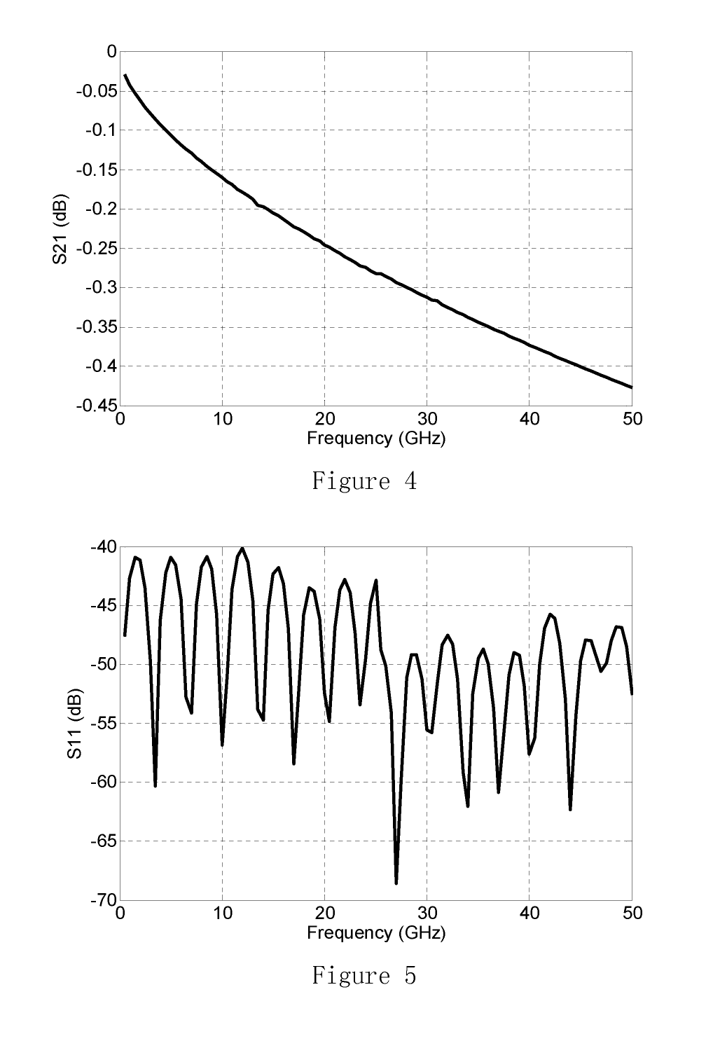

Take the 2×2-channel SICL array in board level as an example, Rogers RT/duroid 5880 is used as the substrate. The relative permittivity of dielectric is 2.2 and the loss tangent is 0.0009. The dimensions are as following: a=2 mm, b=0.37 mm, t=0.018 mm, h=0.254 mm, d=0.4 mm, s=0.6 mm, 1=30 mm. The insertion loss S21 and return loss S11 of a channel in the SICL array are shown in FIG. 4 and FIG. 5, respectively. In the figures, the horizontal axes represent frequency and the vertical axes represent S parameters.

In summary, the SICL array designed in the embodiment has the advantages of wide band, low loss, low delay, low crosstalk and strong ability to resist EMI, and is easy to be expanded. Therefore it is suitable for multichannel parallel data transmission in board level/package level/chip level.

The specific example of the present invention is described above. It should be noted that the invention is not limited to the specific way of implementation. In this field, technicians can make various deformations or modifications within the scope of claims, which does not affect the essence of the invention.

What is claimed is:

1. A substrate integrated coaxial line (SICL) array, wherein the SICL array is a quasi-shielding structure; a physical structure of the SICL array comprises at least a single channel, wherein the channel comprises a first outer conductor layer, a first dielectric layer, a inner conductor layer, a second dielectric layer, a second outer conductor layer and metal vias columns;
the inner conductor layer is between the first outer conductor layer and the second outer conductor layer; the first dielectric layer is between the first outer conductor layer and the inner conductor layer; the second dielectric layer is between the inner conductor layer and the second outer conductor layer; the metal vias columns are across the single channel structure in a vertical direction;
the first outer conductor layer, the second outer conductor layer and the metal vias columns form an outer conductor of a single channel; many single channels in horizontal and vertical directions form the SICL array, wherein adjacent channels share outer conductors;
transverse electromagnetic (TEM) wave is used in the SICL array to propagate signal, and multichannel data parallel transmission can be realized.

2. The SICL array, as recited in claim 1, wherein vertically adjacent channels share outer conductor layers, namely, the second outer conductor layer of an upper channel is a first outer conductor layer of a lower channel.

3. The SICL array, as recited in claim 1, wherein there are two columns of metal vias in each channel which are arranged along a length direction of a physical structure of the SLCL array with a same distance between two columns; two horizontally adjacent channels share a same metal vias column therebetween

4. The SICL array, as recited in claim 3, wherein each of the metal vias columns comprises several metal vias, wherein a distance between adjacent vias is the same.

5. The SICL, as recited in claim 4, wherein a metal via diameter is d, a distance between adjacent metal vias is s; a distance between two adjacent metal vias columns is a; a number of metal vias in each of the metal vias columns depends on a length of the physical structure.

6. The SICL array, as recited in claim 1, wherein a thickness of the first outer conductor layer, the inner conductor layer and the second outer conductor layer are all t, a thickness of the first dielectric layer and the second dielectric layer are both h, and the length of the physical structure is l.

7. The SICL array, as recited in claim 3, the inner conductor layer has at least a metal structure which is arranged in a middle of the two adjacent metal vias columns.

8. The SICL array, as recited in claim 7, wherein a metal structure width is smaller than a width of the outer conductor layer.

9. The SICL array, as recited in claim 1, the first outer conductor layer and the second outer conductor layer are metal layers.
